(19) United States
(12) Patent Application Publication
(10) Pub. No.: US 2005/0234183 A1
(43) Pub. Date: Oct. 20, 2005

(54) Compatibility improvement achieved by syndiotactic polypropylene

(75) Inventor: Martin Ottow, Hof (DE)

Correspondence Address: VENABLE LLP, P.O. BOX 34385, WASHINGTON, DC, 20045-9998, US

(73) Assignee: Rehau AG & Co., Rehau (DE)

(21) Appl. No.: 10/517,842

(22) PCT Filed: Jun. 10, 2003
(86) PCT No.: PCT/EP03/06020

§ 371 Date: Dec. 15, 2004

(30) Foreign Application Priority Data
Jun. 15, 2002 (DE) 102 26 698.0

(51) Int. Cl. C08K 3/26; C08K 3/00

(52) U.S. Cl. 524/515; 524/425

(57) ABSTRACT

A composition comprising thermoplastic elastomers on the basis of a PP/EPDM blend with cross-linked EPDM phase and syndiotactic polypropylene in a viscosity promoter amount.

The invention relates to the use of syndiotactic polypropylene in thermoplastic elastomers on the basis of a PP/EPDM blend with cross-linked EPDM phase.

Even though thermoplastic elastomers have long been known to those skilled in the art, they have become increasingly more important in recent years. This growth can be traced back to the interesting combination of rubber-like material characteristics in connection with the option of a thermoplastic processing. Depending on the chemical composition, a distinction is made between block copolymers of a macromolecular architecture, for example styrene-type “TPE-S,” polyetheramide “TPE-A,” etc. and elastomeric blends which are simultaneously composed of a thermoplastic phase, a phase that is not cross-linked, and a partial and/or fully cross-linked phase, wherein the cross-linking takes place during the processing.

Most widely used is the group of thermoplastic elastomers on the basis of polyolefin blends. High-molecular EPDM copolymers and terpolymers are generally used for the soft phase. Phenol resins (see U.S. Pat. No. 4,104,210), or peroxides (see U.S. Pat. No. 4,267,080), or a hydrosilylation reaction (see EP 0 855 426), for example, are used to achieve the cross-linking during the processing. Nowadays, phenol resins are used almost exclusively to achieve cross-linking.

The physical properties of thermoplastic elastomers on the basis of a PP/EPDM blend essentially depend on whether a hard/soft morphology forms during the processing. As a result of this so-called dynamic cross-linking, a thermoplastic, continuous polypropylene matrix forms into which cross-linked, spherical EPDM domains are intercalated.

It is generally known that the viscosity ratio between PP and non cross-linked EPDM is decisive for the structure of this morphology. An optimum dispersion of isotactic polypropylene and EPDM is therefore possible only with a far-reaching identical, Theological behavior of both components. However, it also means that only high-molecular PP types could be used so far as a result of the high melt viscosity of EPDM.

The following disadvantages result from this:
Free-flowing recipes that are ready for injection molding and contained high-molecular PP as matrix could not be provided until now.
The use of traditional TPE-V on the basis of the PP/EPDM blend for the extrusion results in surface defects in the form of scaling, in dependence on the extrusion speed and the tool geometry. This so-called sharkskin surface structuring occurs starting with a critical flow rate, which is material-dependent and tool-dependent.

These surface defects are caused by a melt fracture resulting from high elongation stresses due to the sudden acceleration of melt layers adjacent to the wall when these layers abruptly exit the nozzle.

Surface defects of this type are not acceptable for visible parts.

Approximately 1.5 mol % fluoropolymers are presently added as external lubricant to avoid having to lower the extruding speed to economically unacceptable levels for achieving a smooth surface. In the extrusion tool, these fluoropolymers increase the flow speed of layers adjacent to the walls, thus avoiding high speed gradients between the melt inside the tool and the melt immediately after exiting from the tool.

However, the use of fluoropolymers negatively influences the TPE-V material properties. An increase in the shore hardness can be observed, for example, whereas the rigidity and elasticity of the material decrease in the component. From a production-engineering point of view, the extrusion expenditure increases considerably since the fluoropolymer must be mixed with the TPE-V prior to the processing and since additional cleaning steps are required for cleaning the extrusion screw, the extrusion cylinder and the extrusion tools.

The object of this invention consequently was to provide TPE-V recipes which can be used without lubricants, which avoid the aforementioned surface defects in the free-flowing shear rate range for extrusion, and which make it possible to formulate free-flowing injection-molding compounds.

Surprisingly, the problem could be solved by adding syndiotactic polypropylene. Materials with a noticeably lower molecular weight, meaning noticeably lower viscosity, could be used in connection with the polypropylene. The Theological compatibility between EPDM and polypropylene is thus increased by adding syndiotactic polypropylene which, in the process, facilitates the structuring of the desired morphology during the dynamic cross-linking. The fine morphologies which can be obtained in this way manifest themselves in a noticeably improved extrusion surface. Furthermore, compounds of TPE-V can be produced as a result of the above-described, compatibilizing function of the syndiotactic polypropylene. These compounds exhibit a noticeably improved flow behavior, necessary for the injection-molding, thereby avoiding sunken spots or voids which result from insufficient filling of the cavity or a premature adherence of the melt to the cavity.

The thermoplastic elastomers according to the invention, which are based on a TPE-V blend, are distinguished by a noticeably improved surface precipitation without the admixture of a lubricant when they are used for the extrusion processing up to high shear rates.

In the following, the invention is explained in further detail with the aid of three exemplary embodiments.

The recipes listed herein as examples 1-3 have the following composition (shares):

TABLE 1

| | Example 1 | Example 2 | Example 3 |
|---|---|---|---|
| EPDM | 35 | 30 | 20 |
| i-PP | 10 | 15 | 20 |
| s-PP | 2 | 3 | 4 |
| filler material | 10 | 10 | 10 |
| oil | 10 | 10 | 10 |
| alkyl phenol resin | 2 | 2 | 2 |
| SnCl₂ | 0.25 | 0.25 | 0.25 |
| stabilizer | 0.5 | 0.5 | 0.5 |

### EXAMPLES 1-3

In a synchronized double-screw mixer having an L/D ratio of 40, the following components:
isotactic polypropylene, MFR (2.16 kg/230° C.)=4 g/10 min
EPDM, Mooney viscosity at 125° C.=35
syndiotactic polypropylene, MFR (2.16 kg/230° C.)=2.5 g/10 min
calcium carbonate
mineral oil with a viscosity of 450 mPas (at 20° C.)
phenol resin, (softening point 60° C.)
tin chloride, share of tin chloride >98%
stabilizer
   are continuously metered in by means of gravimetric metering elements while gas is removed in the process from the polymer melt via a vacuum pump. The resulting compound exhibits the properties listed in Table 2.

Comparison of Properties:

The following table contains several important mechanical characteristic values for the recipes according to the invention (examples 1-3), which are compared to recipes from prior art (comparison examples 1-2), as well as a qualitative evaluation of the surfaces which can respectively be obtained using the extrusion method.

Commercially available types of TPE-V with a different short hardness are used for the comparison examples 1 and 2.

TABLE 2

| | | | | Com- | |
|---|---|---|---|---|---|
| | Example | Example | Example | parison | Comparison |
| | 1 | 2 | 3 | Example 1 | Example 2 |
| hardness | 55 | 65 | 75 | 55 | 75 |
| [shore A] | | | | | |
| permanent | 30 | 33 | 35 | 30 | 35 |
| com- | | | | | |
| pression | | | | | |
| set | | | | | |
| 70° C./ | | | | | |
| 24 h (%) | | | | | |
| breaking | 6 | 8 | 10 | 5 | 7.5 |
| strength | | | | | |
| [N/mm²] | | | | | |
| surface* | + | ++ | ++ | − | − |

*surface analysis (26 × 2 mm band extrudates):
++ smooth surface
+ sharkskin effect barely visible
− sharkskin effect very visible

1. A composition comprising thermoplastic elastomers on the basis of a PP/EPDM blend with cross-linked EPDM phase and syndiotactic polypropylene in a viscosity promoter amount.

2. Thermoplastic elastomers, comprising:
ethylene propylene terpolymers,
isotactic polypropylene,
syndiotactic polypropylene,
mineral filler material,
mineral oil, and
cross-linking catalyst.

3. The thermoplastic elastomers as defined in claim 2, wherein the ethylene propylene terpolymer has a ter-component selected from the group consisting of 1,4-hexadiene, dicyclopentadiene, and ethylidene norbornene.

4. The thermoplastic elastomers as defined in claim 2, wherein the isotactic polypropylene is selected from the group consisting of polypropylene homopolymers and polypropylene copolymers.

5. The thermoplastic elastomers as defined in claim 2, wherein the mineral filler materials are selected from the group consisting of calcium carbonate, talcum and kaolin.

6. The thermoplastic elastomers as defined in claim 2, wherein the mineral oils are selected from the group consisting of naphthene-based and paraffin-based solvents.

7. The thermoplastic elastomers as defined in claim 2, wherein the cross-linking catalyst is selected from the group consisting of tin-(II)-chloride and salicylic acid.

8. The thermoplastic elastomers as defined in claim 2, wherein the alkyl phenol resin is selected from the group consisting of octylphenol and nonylphenol.

9. The thermoplastic elastomers as defined in claim 2, wherein the ethylene propylene terpolymer is present in amounts between 20 and 50 parts.

10. The thermoplastic elastomers as defined in claim 2, wherein the isotactic polypropylene is present in amounts between 10 and 50 parts.

11. The thermoplastic elastomers as defined in claim 2, wherein the filler materials is present in amounts between 5 and 50 parts.

12. The thermoplastic elastomers as defined in claim 2, wherein the mineral oils is present in amounts between 10 and 50 parts.

13. The thermoplastic elastomers as defined in claim 2, wherein the cross-linking catalyst is present in amounts between 0.1 and 2 parts.

14. The thermoplastic elastomers as defined in claim 2, wherein the alkyl phenol resin is present in amounts between 0.5 and 5 parts.

15. The thermoplastic elastomer according to claim 1, wherein said elastomers have a composition as follows:
ethylene propylene terpolymers,
isotactic polypropylene,
syndiotactic polypropylene,
mineral filler material,
mineral oil, and
cross-linking catalyst.

16. A method for producing the thermoplastic elastomers as defined in claim 1, comprising
1) mixing syndiotactic polypropylene with PP and EPDM in the intake area of a continuously operating double-screw mixer to obtain a melt with the highest possible homogeneity and
2) upstream of the screws, dynamically cross-linking the EPDM by adding the cross-linking resin in the presence of catalyst.

17. An article including seals and profiles comprising the thermoplastic elastomers as defined in claim 1.

18. A method for producing the thermoplastic elastomers as defined in claim 2, comprising
1) mixing syndiotactic polypropylene with PP and EPDM in the intake area of a continuously operating double-screw mixer to obtain a melt with the highest possible homogeneity and
2) upstream of the screws, dynamically cross-linking the EPDM by adding the cross-linking resin in in the presence of catalyst.

19. An article including seals and profiles comprising the thermoplastic elastomers as defined in claim 2.
